(19) United States
(12) Patent Application Publication
(10) Pub. No.: US 2025/0285536 A1
(43) Pub. Date: Sep. 11, 2025

(54) POST-CONFLICT DETECTION NEGOTIATION TO MINIMIZE SECONDARY CONFLICTS

(71) Applicant: TOYOTA MOTOR ENGINEERING & MANUFACTURING NORTH AMERICA, INC., PLANO, TX (US)

(72) Inventors: HAO M. WANG, MOUNTAIN VIEW, CA (US); SERGEI S. AVEDISOV, MOUNTAIN VIEW, CA (US); ONUR ALTINTAS, MOUNTAIN VIEW, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/596,129

(22) Filed: Mar. 5, 2024

(51) Int. Cl. G08G 1/09; H04L 67/12; H04W 64/00

(52) U.S. Cl. CPC G08G 1/091; H04L 67/12; H04W 64/006

(57) ABSTRACT

Systems and methods are provided for initiation of emergency post-conflict detection negotiations by a vehicle involved in a primary conflict with nearby vehicles. Examples include detecting a conflict involving an ego vehicle, determining a trajectory of the ego vehicle for a time period after detecting the conflict, predicting a geographic area occupied by the trajectory of the ego vehicle for the time period, identifying one or more remote vehicles adjacent to the geographic area, and initiating negotiations with the identified one or more remote vehicles that reserves the geographic area for the detected conflict and the determined trajectory.

### TECHNICAL FIELD

The present disclosure relates generally to systems and methods for vehicle positioning, and, more particularly, some embodiments relate to a vehicle positioning in indoor and/or underground environments.

### DESCRIPTION OF RELATED ART

Maneuver negotiation (also referred to simply as negotiation) is a type of cooperative maneuvering between vehicles to coordinate complex maneuvers amongst the vehicles. Once negotiated, the coordinated vehicles are able to perform complex maneuvers, such as platooning, merging, lane changing, intersection crossing simultaneously, in a way that allows them to work towards a common goal.

### BRIEF SUMMARY OF THE DISCLOSURE

According to various embodiments of the disclosed technology, systems and methods for initiation of emergency post-conflict detection negotiations by one or more vehicles involved in a primary conflict with nearby are provided.

In accordance with some embodiments, a method is provided. The method comprises detecting a conflict involving an ego vehicle, determining a trajectory of the ego vehicle for a time period after detecting the conflict, predicting a geographic area occupied by the trajectory of the ego vehicle for the time period, identifying one or more remote vehicles adjacent to the geographic area, and initiating negotiations with the identified one or more remote vehicles that reserves the geographic area for the detected conflict and the determined trajectory.

In another aspect, a vehicle is provided that comprises a memory storing instructions and one or more processors communicably coupled to the memory. The one or more processors are configured to execute the instructions to detect a conflict involving the vehicle, determine a first trajectory of the vehicle for a time period after detecting the conflict, predict a geographic area occupied by the first trajectory for the time period, identify one or more remote vehicles adjacent to the geographic area, and initiate negotiations with the identified one or more remote vehicles that reserves the geographic area for the detected conflict and the first trajectory.

In another aspect, a system is provided that comprises a post-conflict negotiation circuit. The a post-conflict negotiation circuit is configured to execute instructions stored in a memory to detect a conflict including an ego vehicle, and, based on detecting the conflict, transmit one or more maneuver messages to one or more remote vehicles adjacent to the conflict. The one or more maneuver messages comprise information indicating a geographic area for the conflict and instructions for the one or more remote vehicles to avoid the geographic area.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for emergency post-conflict detection negotiation in accordance with one embodiment of the systems and methods described herein.

FIG. 3 is a schematic block diagram of an example post-conflict negotiation architecture, in accordance with an illustrative embodiment of the disclosed technology.

FIG. 4 is a flow chart illustrating example operations for post-conflict negotiation in accordance with various embodiments disclosed herein.

FIG. 5 is a flow chart illustrating example operations for emergency post-conflict negotiation initiation in accordance with various embodiments disclosed herein.

FIG. 6A-6E depict an example use case of post-collision negotiations in accordance with an embodiment.

FIG. 7A-7E depict another example use case of post-collision negotiations in accordance with an embodiment.

FIG. 8A-8E depict yet another example use case of post-collision negotiations in accordance with an embodiment.

FIG. 9 is an example computing component that may be used to implement various features of embodiments described in the present disclosure.

The figures are not exhaustive and do not limit the present disclosure to the precise form disclosed.

### DETAILED DESCRIPTION

Embodiments of the present disclosure provide for initiation of emergency post-conflict detection negotiations by one or more vehicles involved in a primary conflict with nearby vehicles that are not involved in the primary conflict. Embodiments disclosed herein provide for detecting an occurrence of a primary conflict, which triggers emergency post-conflict detection negotiations with other vehicles in the vicinity (e.g., traveling adjacent to the conflict along the same section of roadway) with an aim to minimize exposure of the other vehicles to secondary conflicts. For example, an ego vehicle involved in a primary conflict can predict a first geographic area that will be occupied by the primary conflict, such as the ego vehicle and any other agents (e.g., vehicles, pedestrian, etc.) involved in the primary conflict. Based on the first geographic area, the ego vehicle can predict a second geographic area to be avoided by other vehicles that are not involved in the primary conflict. The second geographic area may encompass the first geographic area. Based on this prediction, the ego vehicle can execute emergency post-conflict detection negotiations with the other vehicles to reserve the second geographic area to ensure safe maneuver for itself and for the other vehicles.

As used herein a “conflict” may refer to a collision or a potential collision between road agents (e.g., vehicles, pedestrians, animals, roadside infrastructure, or any object). A conflict may be between vehicles (e.g., a vehicle-to-vehicle conflict), between a vehicle and a pedestrian (e.g., a vehicle-to-pedestrian conflict), and between a vehicle and the environment (e.g., a vehicle-to-environment conflict). A “primary conflict” refers to a conflict that is not caused by another conflict, such as a previously occurring conflict. While a “secondary conflict” refers to a conflict that is a result of (e.g., causally related to) a previously occurring conflict, where the previously occurring conflict can be a primary or a prior secondary conflict. For example, a collision originally happening between two vehicles may further cause secondary conflicts involving more surrounding vehicles. As another example, a vehicle that maneuvers to avoid a potential collision may further cause secondary conflicts involving surrounding vehicles.

Generally, as described above, negotiation refers to a type of cooperative maneuvering that allows vehicles to coordinate complex maneuvers. Negotiation may be used bring benefits over scenarios where vehicles may not be able cooperate. Thus, negotiations are being standardized in both the United States, by the Society of Automotive Engineers (SAE), and in Europe, by European Telecommunications Standards Institute (ETSI).

Conventionally, standardization considers negotiations as a way to manage primary conflicts between vehicles. However, a large portion of conflicts are post-conflict safety hazards (e.g., secondary conflicts) caused be a prior conflict, whether secondary or primary. Managing such post-conflict safety hazards may minimize these secondary conflicts.

Accordingly, the technology of the present disclosure provide for emergency post-conflict detection negotiations that can be used to minimize exposure of vehicles, not involved in a primary conflict, to risks of a secondary conflict. For example, an ego vehicle can be configured to detect a conflict between the ego vehicle and an object, such as another vehicle, pedestrian, environmental object, etc. The ego vehicle may detect that it is involved in a collision with the object or it is at risk of a potential collision with the object. Responsive to the detection, the ego vehicle may initiate emergency post-conflict negotiations with at least one remote vehicle in the nearby area to coordinate maneuvers with the at least one remote vehicle and avoid a secondary conflict with the at least on remote vehicle. The post-conflict detection negotiation as disclosed herein are not currently considered under the standardizations set forth by SAE and ETSI.

In various embodiments, the ego vehicle may predict a geographic area to be avoided, which can be communicated to the at least one remote vehicle. For example, the ego vehicle may detect that it is involved in a conflict and determine at least a trajectory of the ego vehicle for a determined time period after the occurrence of the conflict. The trajectory may be determined based on vehicle data obtained intrinsically by the ego vehicle (e.g., based on sensors installed on the vehicle) and/or extrinsically by the ego vehicle (e.g., from the object or nearby vehicles). The ego vehicle may then predict a first geographic area that will be occupied by the conflict during the determined time period based on the predicted trajectory of the ego vehicle. Using the first geographic area, the ego vehicle may determine a second geographic area that comprises the first predicted geographic area and a clearance (or padding) region, such that the second geographic area can encompass the entirety of the first predicted geographic area. The clearance area may be selected to provide a space between the first predicted geographic area and any remote vehicles in the vicinity so to avoid a secondary conflict.

In some embodiments, the first geographic area may be composed of a plurality of sub-regions. For example, the ego vehicle may predict a first sub-region based on the predicted trajectory of the ego vehicle and one or more second sub-regions based on trajectories of other objects involved in the conflict. The ego vehicle may be configured to predict one or more trajectories of one or more other objects involved in the conflict and predict one or more second sub-regions based on the predict trajectories. The first and second sub-regions may collectively represent the first geographic area that the conflict will occupy for the determined time period.

As alluded to above, the ego vehicle may initiate emergency negotiations (e.g., post-conflict detection negotiations) with at least one remote vehicles to coordinate avoidance of the second geographic area. Based on the emergency negotiation, the at least one vehicle can be operated, either autonomously or semi-autonomously, so to avoid traveling into the second geographic area. For example, the ego vehicle may determine whether any remote vehicles are present in the vicinity of the first geographic area and, responsive to the determination, initiate emergency negotiations with the determined remote vehicles (if any) to inform the remote vehicles of the conflict and reserve the second geographic area for the conflict. In various examples, the ego vehicle may predict trajectories of remote vehicles in the vicinity, for example, based on intrinsic or extrinsic vehicle data and determine if any of the predicted trajectories intersect with the second geographic area. Responsive to the determination, the ego vehicle can initiate emergency negotiations with those nearby vehicles corresponding to the trajectories predicted to intersect with the second geographic area. Negotiations may not be needed with remote vehicles who are not predicted to intersect with the second geographic area as they are not at risk (or at least at a lower risk) of a secondary conflict.

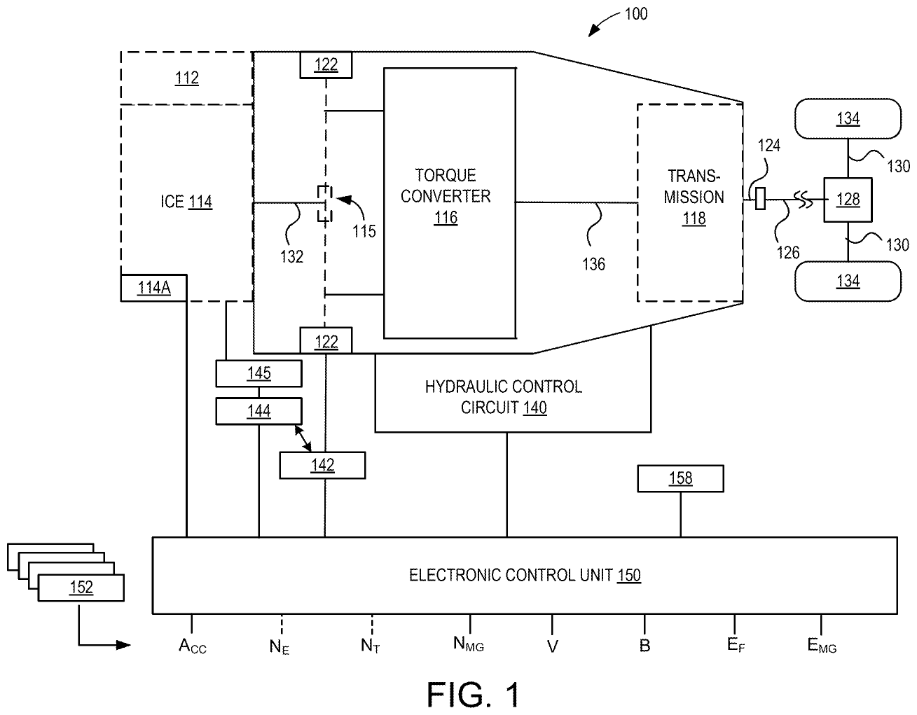

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for emergency post-conflict detection negotiation can be implemented in other types of vehicle including gasoline- or diesel-powered vehicles, fuel-cell vehicles, electric vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount (A_{CC}), a revolution speed (N_{E}) of internal combustion engine 114 (engine RPM), a rotational speed (N_{MG}) of the motor 122 (motor rotational speed), and vehicle speed (N_{V}). These may also include torque converter 116 output (N_{T}) (e.g., output amps indicative of motor output), brake operation amount/pressure (B), and battery SOC (i.e., the charged amount for battery 144 detected by an SOC sensor). Accordingly, vehicle 100 can include a plurality of sensors 152 that can be used to detect various conditions internal or external to the vehicle, and provide sensed conditions to electronic control unit 150 (which, again, may be implemented as one or a plurality of individual control circuits). In one embodiment, sensors 152 may be included to detect one or more conditions directly or indirectly such as, for example, fuel efficiency (E_{F}), motor efficiency (E_{MG}), hybrid (internal combustion engine 114+MG 122) efficiency, acceleration (A_{CC}), etc.

In some embodiments, one or more of the sensors 152 may include their own processing capability to compute the results for additional information that can be provided to electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

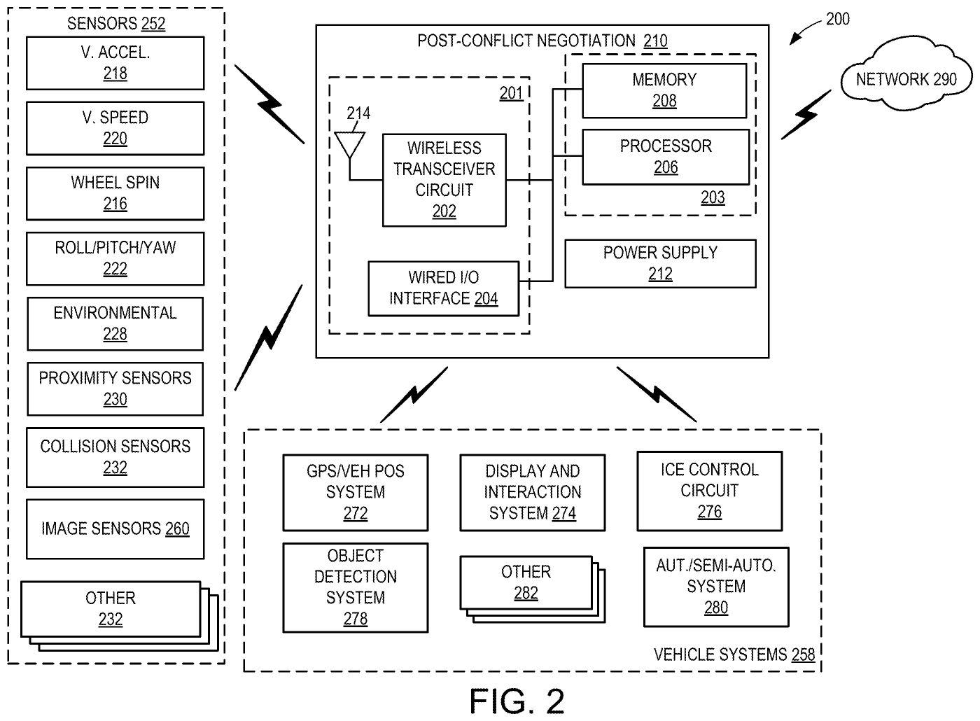

FIG. 2 illustrates an example architecture for emergency conflict negotiation in accordance with one embodiment of the systems and methods described herein. Referring now to FIG. 2, in this example, emergency conflict negotiation system 200 includes a post-conflict negotiation circuit 210, a plurality of sensors 252 and a plurality of vehicle systems 258. Sensors 252 (such as sensors 152 described in connection with FIG. 1) and vehicle systems 258 (such as subsystems 158 described in connection with FIG. 1) can communicate with post-conflict negotiation circuit 210via a wired or wireless communication interface. Although sensors 252 and vehicle systems 258 are depicted as communicating with post-conflict negotiation circuit 210, they can also communicate with each other as well as with other vehicle systems. post-conflict negotiation circuit 210can be implemented as an ECU or as part of an ECU such as, for example electronic control unit 150. In other embodiments, post-conflict negotiation circuit 210can be implemented independently of the ECU.

Post-conflict negotiation circuit 210 in this example includes a communication circuit 201, a decision circuit 203 (including a processor 206 and memory 208 in this example) and a power supply 212. Components of post-conflict negotiation circuit 210are illustrated as communicating with each other via a data bus, although other communication in interfaces can be included. Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store instructions and variables for processor 206 as well as any other suitable information, such as, one or more of the following elements: position data of the vehicle and/or remote vehicles; vehicle speed data of the vehicle and/or remote vehicles; heading direction data of the vehicle and/or remote vehicles; trajectory data of the vehicle and/or remote vehicles; along with other data as needed. Memory 208 can be made up of one or more modules of one or more different types of memory, and may be configured to store data and other information as well as operational instructions that may be used by the processor 206 to post-conflict negotiation circuit 210.

Memory 208 may also store one or more vehicle dynamics models that can be executed to predict trajectories of the vehicle and/or other remote vehicles in the vicinity based on vehicle data of the vehicle and/or remote vehicles. Vehicle dynamics models as used herein refers to algorithms that define kinematics of a particular vehicle, which can be used to predict trajectories of the vehicle based on information about the vehicle and vehicle states, such as position data, speed data, and heading data of the vehicle. A trajectory may be determined from vehicle data applied to the vehicle dynamics model. For example, a trajectory may be composed of a sequence of vehicle states (s₀, s₁, . . . , s_{T}) over a period of time (T). The vehicle states may include vehicle position data, heading data, and speed data, among other information about the vehicle (e.g., weight, suspension properties, etc.). Thus, vehicle states derived from vehicle data may be applied to vehicle dynamics models stored in the memory 208 to predict a trajectory of a vehicle for a period of time beyond that covered by the vehicle data by predicting a sequence of vehicle states.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a post-conflict negotiation circuit 210.

Communication circuit 201 includes either or both a wireless transceiver circuit 202 with an associated antenna 214 and a wired I/O interface 204 with an associated hardwired data port (not illustrated). Communication circuit 201 can provide for vehicle-to-everything (V2X) and/or vehicle-to-vehicle (V2V) communications capabilities, allowing post-conflict negotiation circuit 210 to communicate with edge devices, such as roadside unit/equipment (RSU/RSE), network cloud servers and cloud-based databases, and/or other vehicles via network 290. For example, V2X communication capabilities allows post-conflict negotiation circuit 210 to communicate with edge/cloud servers, roadside infrastructure (e.g., such as roadside equipment/roadside unit, which may be a vehicle-to-infrastructure (V2I)-enabled street light or cameras, for example), etc. post-conflict negotiation circuit 210may also communicate with other connected vehicles over vehicle-to-vehicle (V2V) communications.

As this example illustrates, communications with post-conflict negotiation circuit 210can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by post-conflict negotiation circuit 210to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or may not otherwise be included on a standard vehicle with which the emergency conflict negotiation system 200 is implemented. In the illustrated example, sensors 252 include vehicle acceleration sensors 218, vehicle speed sensors 220, wheelspin sensors 216 (e.g., one for each wheel), accelerometers such as a accelerometer 222 (e.g., 2-axis, 3-axis, or multi-axis accelerometers) to detect roll, pitch and yaw of the vehicle, environmental sensors 228 (e.g., to detect salinity or other environmental conditions), proximity sensor 230 (e.g., sonar, radar, lidar or other vehicle proximity sensors), collision sensors 232 to detect an impact with the vehicle. Additional sensors 232 can also be included as may be appropriate for a given implementation of emergency conflict negotiation system 200, for example, airbag sensors configured to detect deployment of airbags, such as in response to an accident).

System 200 may be equipped with one or more image sensors 260. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 260 can be used to, for example, to detect objects in an environment surrounding a vehicle comprising emergency conflict negotiation system 200, for example, surrounding vehicles, roadway environment, road lanes, road curvature, obstacles, pedestrians, cyclists, and so on. For example, a one or more image sensors 260 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 260 may include cameras that may be used with and/or integrated with other proximity sensors 230 such as LIDAR sensors or any other sensors capable of capturing a distance. As used herein, a sensor set of a vehicle may refer to sensors 252.

Vehicle systems 258, for example, systems and subsystems 158 described above with reference to the example of FIG. 1, can include any of a number of different vehicle components or subsystems used to control or monitor various aspects of the vehicle and its performance. In this example, the vehicle systems 258 includes a vehicle positioning system 272; engine control circuits 276 to control the operation of engine (e.g. internal combustion engine 114 and/or motors 122); object detection system 278 to perform image processing such as object recognition and detection on images from image sensors 260, proximity estimation, for example, from image sensors 260 and/or proximity sensors, etc. for use in other vehicle systems; vehicle display and interaction system 274 (e.g., vehicle audio system for broadcasting notifications over one or more vehicle speakers), vehicle display system and/or the vehicle dashboard system), and other vehicle systems 282 (e.g., Advanced Driver-Assistance Systems (ADAS), autonomous or semi-autonomous driving systems 280, such as forward/rear collision detection and warning systems, pedestrian detection systems, autonomous or semi-autonomous driving systems, and the like).

The vehicle positioning system 272 can include a global positioning system (GPS). Post-conflict negotiation circuit 210 may be installed on a DSRC-equipped vehicle. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

Autonomous or semi-autonomous driving systems 280 can be operatively connected to the various vehicle systems 258 and/or individual components thereof. For example, autonomous or semi-autonomous driving systems 280 can send and/or receive information from the various vehicle systems 258 to control the movement, speed, maneuvering, heading, direction, etc. of the vehicle. The autonomous or semi-autonomous driving systems 280 may control some or all of these vehicle systems 258 and, thus, may be semi- or fully autonomous.

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V2I, LTE-V2X, LTE-D2D, VOLTE, 5G-V2X or any other mobile data network or combination of mobile data networks. Further, the network 290 may include one or more IEEE 802.11 wireless networks.

In some embodiments, the network 290 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs), Maneuver Messages (MMs), Sensor Data Messages (SDMs), and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VOLTE); etc. In some examples, the V2X communications can include V2V communications, Vehicle-to-Infrastructure (V2I) communications, Vehicle-to-Network (V2N) communications or any combination thereof.

BSMs are wireless message transmitted between road agents, such as vehicles. BSMs are used to exchange position data, speed data, heading data, and other static and/or dynamic information of between connected vehicles. In some cases, BSMs are standardized by SAE and the information included in a BSM can be as defined in the SAE J2735 standards.

MMs are another format of messages exchanged between road agents, as well as between road agents and road-side infrastructure. Each MM can contain a future trajectory (or possible future trajectories) of a transmitting road agent. Examples of MMs include, but are not limited to, Maneuver Coordination Messages (MCMs) currently undergoing standardization by the ETSI and the Maneuver Sharing Coordination Messages (MSCMs) currently being standardized by SAE.

SDMs are another format of messages that can be exchanged between road agents, as well as between road agents and infrastructure. Each SDM contains information about objects detected in an environment in which the transmitting vehicle is traveling, such as but not limited to, a class of the object (e.g., structure, pedestrian, cyclist, road sign, roadside infrastructure, etc.), position of the object, speed of the object, size of the object, etc. Examples of SDMs include, but are not limited to, Collective Perception Message (CPMs) that are undergoing standardization by ETSI and Sensor Data Sharing Message (SDSMs) that have been standardized by SAE.

During operation, communication circuit 201 can be used to transmit and receive information between post-conflict negotiation circuit 210 and sensors 252, and post-conflict negotiation circuit 210 and vehicle systems 258. Also, sensors 252 may communicate with vehicle systems 258 directly or indirectly (e.g., via communication circuit 201 or otherwise). Received information, such as vehicle data, can be stored in memory 208 for use by post-conflict negotiation circuit 210 and/or vehicle systems 258. Information for transmission may be received by post-conflict negotiation circuit 210, stored in memory 208, and then transmitted to remote destinations using communication circuit 201 via network 290. Received and transmitted information may comprise intrinsic vehicle data obtained from sensors 252 and/or vehicle systems 258, as well as extrinsic vehicle data received via network 290, such as from a remote vehicle. Extrinsic vehicle data may be included in one or more of BSMs, MMs, and SDMs, as described above, that can be received from a remote vehicle.

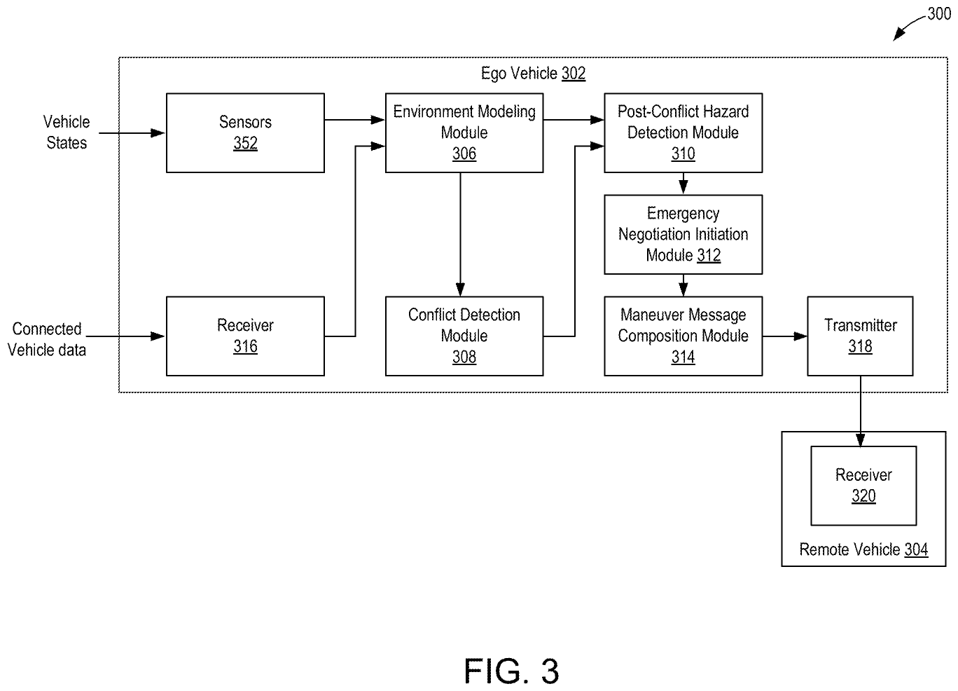

FIG. 3 is a schematic block diagram of an example post-conflict negotiation architecture 300, in accordance with an illustrative embodiment of the disclosed technology. Post-conflict negotiation architecture 300 comprises an ego vehicle 302 and one or more vehicles, illustratively shown as vehicle 304. Vehicle 304 may be remote from ego vehicle 302 in that the vehicles do not occupy the same geographic space and, as such, are spaced apart from each other. In an example, ego vehicle 302 and vehicle 304 may be traveling in the same environment (e.g., along a common section of a road) at approximately the same time. Ego vehicle 302 and/or vehicle 304 may each comprise a post-conflict negotiation circuit 210 of FIG. 2. As such, ego vehicle 302 and vehicle 304 may be communicatively connected to each other via V2V communications over a network (e.g., network 290). While FIG. 2 depicts ego vehicle 302 connected to vehicle 304, vehicle 302 may be communicatively connected to a plurality of vehicles within the environment.

Ego vehicle 302 comprises plurality of modules 306-314 configured to store data and other information as well as operational instructions that may be executed, for example, by a processor. With reference to FIG. 2, modules 306-314 may be stored in memory 208 that may be executed by processor 206 of post-conflict negotiation circuit 210. Ego vehicle 302 comprises an environment modeling module 306, a conflict detection module 308, a post-conflict hazard detection module 310, emergency negotiation initiation module 312, and a maneuver message composition module 314. Other modules may be included in ego vehicle 302.

Ego vehicle 302 also comprises a receiver 316 and a transmitter 318. Receiver 316 and transmitter 318 may be implemented, for example, as part of communication circuit 201 of FIG. 2 above. For example, receiver 316 may be wireless transceiver circuit 202 or wired I/O interface 204 depending on whether information is received wirelessly or through a wired connection. Similarly, receiver 316 may be wireless transceiver circuit 202 or wired I/O interface 204.

Sensor 352 can include, for example, sensors 252 and/or vehicle systems 258 described above with reference to the example of FIG. 2. Sensors 352 may detect vehicle states of the ego vehicle while traveling, such as position data, speed data, heading data, and other static and/or dynamic information. The sensors 352 may also detect objects in and states of the surrounding environment. The objects may comprise nearby vehicles, pedestrians, cyclist, etc. in the environment. The objects may also comprise inanimate objects, such as structures, roadways, sidewalks, etc. may be detected based on sensor 352. Sensor 352 can detect position data, speed data, heading data, and other static and/or dynamic information of the various objects within the environment. Data collected by the sensor 352 may be referred to as vehicle or sensor data and may be examples of intrinsic vehicle or sensor data.

Receiver 316 can be configured to receive vehicle data from connected vehicles in the vicinity. The vehicle data received from connected vehicles may be similar to the vehicle data collected by sensor 352 above. For example, connected vehicles may use their own sensors to collected vehicle states and transmit these states to receiver 316 of the ego vehicle 302. In an example, receiver 316 may receive one or more of BSMs, SDMs, and/or MMs from the connected vehicles in the vicinity. The vehicle data received from other connected vehicles may be referred to as extrinsic vehicle data.

Environment modeling module 306 is configured to generate a virtual model of surrounding environment by fusing sensor data received from sensor 352 with the connected vehicle data received by receiver 316. Environment modeling module 306 can be configured to create a representation of the surrounding environment, that the ego vehicle 302 can use to gain an understanding of the objects and states in the surroundings. This information can also include current trajectories (e.g., sequences of states) of any nearby vehicles and/or objects.

Conflict detection module 308 is configured to detect a conflict involving the ego vehicle 302. In one example, conflict detection module 308 may utilize collision sensors to detect that ego vehicle 302 is involved in an actual collision with another object (e.g. another vehicle or otherwise). As another example, conflict detection module 308 may register a collision using airbag sensors to detect deployment of airbags, which can be generally indicative of a collision. In another example, conflict detection module 308 may utilize sensors 352 and the virtual model of the environment from environment modeling module 306 to detect a potential collision. For example, environment modeling module 306 may detect conditions in the environment and current vehicle states of ego vehicle 302 that indicate a collision may occur. As an illustrative example, a vehicle behind ego vehicle 302 maybe traveling at high speed and a vehicle in front of ego vehicle 302 may have stopped suddenly. Conflict detection module 308 may use these conditions to detect that ego vehicle 302 is at risk of an impending collision and register a conflict.

Post-conflict hazard detection module 310 is configured to predict a post- conflict hazards for vehicles in the vicinity of the collision detected by conflict detection module 308. Post-conflict hazard detection module 310 may be configured to determine if nearby vehicles in the environment are at risk of a post-conflict hazard (e.g., secondary conflict). In examples, post-conflict hazard detection module 310 may be configured to predict a first geographic area that will be occupied by the detected conflict (e.g., primary conflict). Post-conflict hazard detection module 310 can then predict a second geographic area to be avoided by other vehicles that are not involved in the primary conflict, but may be at risk of a secondary conflict.

For example, post-conflict hazard detection module 310 may predict the first geographic area based on predicting a trajectory of ego vehicle 302. Post-conflict hazard detection module 310 may access a vehicle dynamics models (e.g., stored in a memory) and apply states of the ego vehicle 302 (and other objects) to the models. The models may be adjusted to account for changes on the ego vehicle 302 (or other objects). For example, post-conflict hazard detection module 310 may recognize changes to vehicle kinematics that impact trajectory prediction and adjust the vehicle dynamics model accordingly. As an illustrative example, post-conflict hazard detection module 310 may detect that a tire deflated during the conflict, which changed the handling properties of the vehicle. Post-conflict hazard detection module 310 may then adjust the vehicle dynamics model to account for the change in operation.

In some examples, post-conflict hazard detection module 310 may be configured to predict the first geographic area based on predicting trajectories of other objects involved in the conflict, as well as a predicted trajectory for ego vehicle 302. Post-conflict hazard detection module 310 may be able to predict trajectories of involved objects if post-conflict hazard detection module 310 has access to sufficient data of the object and a model from which a trajectory can be predicted. For example, where the other object is another vehicle, post-conflict hazard detection module 310 may obtain vehicle states of the other vehicle, either intrinsically or extrinsically, and apply the vehicle states to a vehicle dynamics model to predict the trajectory, similar to predicting the trajectory of ego vehicle 302.

Using the predicted trajectories, post-conflict hazard detection module 310 may be configured to predict a first geographic area that will be occupied by the conflict. For example, a predict trajectory may comprise a number of predicted trajectories and probabilities (e.g., uncertainty) of each predict trajectory being representative of a true, unknown trajectory. Post-conflict hazard detection module 310 may define a trajectory prediction area (e.g., sub-region) that comprises the spread of predicted trajectories. In an example, post-conflict hazard detection module 310 may predicts trajectories for ego vehicle 302 as a first sub-region. In the case where post-conflict hazard detection module 310 predicts trajectories for only ego vehicle 302, the first geographic area may correspond to the first sub-region. In another example, post-conflict hazard detection module 310 may also predict trajectories of other objects, such as road agents, involved as one or more second sub-regions. In this case, the first geographic area may correspond to a combination of the first and second sub-regions.

Post-conflict hazard detection module 310 can be configured to determine a second geographic area based on the first geographic area. In various examples, post-conflict hazard detection module 310 may define a second geographic area the encompasses the first geographic area. Post-conflict hazard detection module 310 may also add a clearance region to the first geographic area. The clearance region may operate to expand the second geographic area beyond the extent of the first geographic area to provide clearance of the conflict to the nearby vehicles not involved in the conflict. In some examples, the clearance region may be a parameter added to edges of the first geographic area. The parameter may be set depending on how conservative post-conflict hazard detection module 310 is set to be in providing a clear area around the conflict. For example, smaller parameters may be used for less traffic dense areas (e.g., side of a road), while larger parameters may be used for areas of a road where traffic may be present. In another example, the clearance region may be based on bounding boxes (e.g., as determined by object detection system 278) of nearby vehicles. For example, post-conflict hazard detection module 310 may obtain bounding boxes representing each object on the road and may define a clearance region that ensures the bounding box can avoid the first area based on a trajectory of the vehicle corresponding to the bounding box.

Post-conflict hazard detection module 310 can also be configured to determine if any remote vehicles (e.g., vehicle 304) are exposed to a post-conflict hazard (e.g., at risk of a potential secondary conflict). For example, post-conflict hazard detection module 310 may be configured to predict trajectories of remote vehicles traveling in the vicinity. For example, post-conflict hazard detection module 310 may obtain intrinsic and/or extrinsic vehicle data and the virtual model of the environment from environment modeling module 306 and predict trajectories for each nearby vehicle, similar to the prediction of the trajectory for ego vehicle 302. The predicted trajectories for the nearby vehicles may provide a trajectory prediction area, similar to that of ego vehicle 302 described above. Post-conflict hazard detection module 310 may then identify any nearby vehicle associated with a predicted trajectory (e.g., trajectory prediction area) that overlaps or intersects with the second geographic area. The identified vehicles may be recorded as an at-risk vehicle because it is at risk of a potential secondary conflict. In the example of FIG. 3, vehicle 304 may be identified as an at risk vehicle.

In some examples, post-conflict hazard detection module 310 may detect remote vehicles traveling in the vicinity (e.g., nearby) the conflict and, thus, exposed to a post-conflict hazard. Detecting whether a remote vehicle is in the vicinity of the conflict may be based on a distance between a conflict and a remote vehicle (referred to as a distance metric) and/or an amount of time between a remote vehicle and a conflict (referred to as a time metric). The distance and/or time metrics may be based on a distance and/or an amount of time between the remote vehicle and a post-conflict hazard, opposed to the conflict itself. The post-conflict hazard detection module 310 may determine a distance and/or time metric and compare the distance and/or time metric to a threshold distance and/or threshold time, respectively. If the determined parameter is less or equal to the threshold, the remote vehicle is identified as being in the vicinity of the conflict.

The threshold may be scenario dependent. As an illustrative example, in the case of a highway scenario a remote vehicle may be identified in vicinity using a time metric, such as an amount of time to a predicted collision (e.g., post-conflict hazard) or an amount of time to the conflict itself. Time to collision can be obtained by estimating an amount of time between a current real-world position of a remote vehicle and a time until trajectories of the remote vehicle and another vehicle intersect (e.g., will collide with another vehicle). Time to conflict can be obtained by estimating an amount of time between a current real-world position of a remote vehicle and a time until the trajectory of the remote vehicle enters the an area of the conflict (e.g., a geographic area reserved for the conflict). The predicted time to collision or time to conflict can be compared to a set threshold (e.g., 10 seconds, 5 second, etc.) to determine if the remote vehicle is in the vicinity of the conflict. The threshold itself may be application dependent, for example, the threshold may be larger for low traffic congestion due to faster moving traffic, lower for high traffic congestion due to slower moving traffic, higher for highways compared to surface streets, etc. In another example, a similar metric referred to as “gap time” (e.g., amount of time of an opening in an intersection in which a remote vehicle can pass) can be used in intersection applications.

Emergency negotiation initiation module 312 is configured to initiate emergency post-conflict negotiation to coordinate maneuvers between the ego vehicle 302 and vehicles identified by post-conflict hazard detection module 310 (e.g., vehicle 304 in this example). Emergency negotiation initiation module 312 may establish a maneuver negotiation session with vehicle 304. In various examples, establishing a maneuver negotiation session may comprises exchanging a maneuver message, for example, by ego vehicle 302 sending the maneuver message and vehicle 304 receiving it . . .

Maneuver message composition module 314 is configured to compose a maneuver message that contains information for coordinating maneuvers between ego vehicle 302 and vehicle 304. The maneuver message may comprise information defining the second geographic area reserved for the conflict and information instructing vehicle 304 to avoid the region. In some examples, the maneuver message may also comprise vehicle states, such as speed, position, and trajectory data of road agents involved in the conflict. In another example, the maneuver message may also comprise instructions on how vehicle 304 can be operated to avoid the second geographic area. For example, the maneuver message may include recommended trajectories for vehicle 304 that define a path to avoid the second geographic area and avoid a secondary conflict. In some embodiments, maneuver message composition module 314 is configured to construct an MM as described above, such as a MCM, MSCM, and the like.

The maneuver message can be communicated to vehicle 304 using transmitter 318. Vehicle 304 receives the maneuver message at its receiver 320 and acts on the maneuver message so to avoid the second geographic area. Its receiver 320 may be wireless transceiver circuit 202 of FIG. 2 that receives the maneuver message via V2V communication with ego vehicle 302. In some examples, a post-conflict negotiation circuit 210 can be included in vehicle 304 that provides the maneuver message to vehicle systems 258, which operate vehicle 304 so to avoid the second geographic area. In some cases, autonomous or semi-autonomous driving systems 280 may receive the information contained in the maneuver message and control the vehicle autonomously or semi-autonomously so to avoid a secondary conflict.

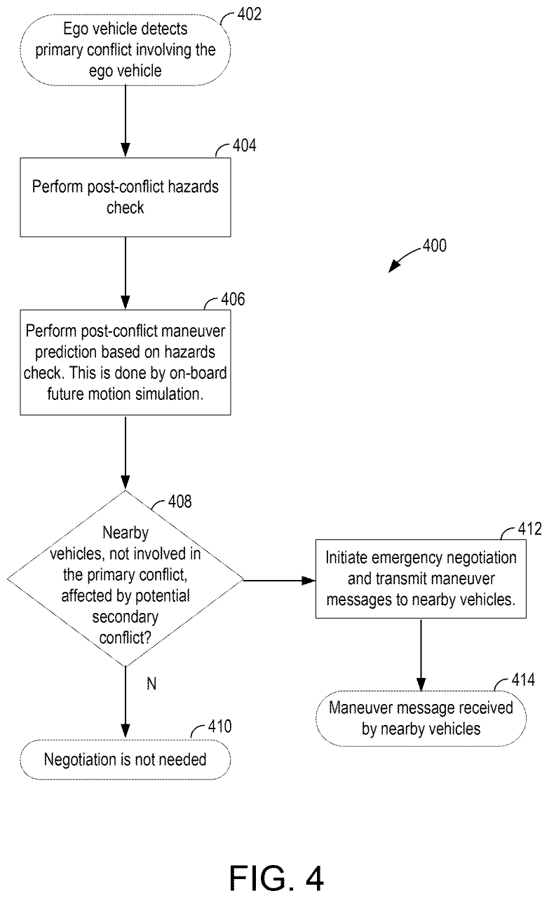

FIG. 4 is a flow chart illustrating example operations for post-conflict negotiation in accordance with various embodiments disclosed herein. Process 400 may be implemented as instructions, for example, stored on post-conflict negotiation circuit 210, that when executed by one or more processors perform one or more operations of process 400. The process 400 will be described below with reference to a vehicle, as an illustrative example. However, one skilled in the art will appreciate that the embodiments disclosed herein are not to be limited to this implementation only. For example, the embodiments disclosed herein may be applied to other non-vehicular systems as desired.

At operation 402, an ego vehicle detects an occurrence of a primary conflict that involves the ego vehicle. For example, operation 402 may detect a collision involving the ego vehicle based on intrinsic and extrinsic vehicle data obtained by the ego vehicle and/or other connected vehicles, as described above in connection with FIG. 3. In some cases, operation 402 may detect the occurrence of a primary conflict using a virtual model of an environment in which the ego vehicle is traveling. The primary conflict may also involve other road agents, such as other vehicles or objects in the environment. In an example implementation, operation 402 may be executed by conflict detection module 308 of FIG. 3 and additional details on operation 402 are provided therein.

At operation 404, a post-conflict hazard check can be executed. For example, operation 404 may be comprise predicting a geographic area (e.g., second geographic area) to be avoided. In some examples, the ego vehicle may predict a trajectory of the ego vehicle for a determined time period (T_{C}) after the occurrence of primary conflict. The ego vehicle may also predict trajectories of other road agents involved in the primary conflict. As explained above in connection with FIG. 3, trajectories may be determined based on intrinsically and/or extrinsically obtained vehicle. Operation 404 may comprise determining a first geographic area that will be occupied by the conflict during the determined time period (T_{C}) based on the predicted trajectories.

Operation 404 may comprise determining a second geographic area based on the first geographic area. For example, operation 404 may comprise defining a second geographic area that comprises a first predicted geographic area and a clearance region, selected to provide a space between the first predicted geographic area and any nearby vehicles so to avoid a secondary conflict. The second geographic area represents a space that vehicles not involved in the primary conflict are to avoid for the determined time period (T_{C}).

The determined time period (T_{C}) may be an adjustable parameter. T determined time period (T_{C}) may represent a time period during which the aftermath of primary conflict may pose a threat to surrounding vehicles and cause secondary conflict. The ego vehicle may vary the prediction horizon (e.g., determined time period (T_{C})) according to a severity and the scenario of the primary conflict.

Similarly, the clearance region may be an adjustable parameter. The clearance region represents a space between the first geographic area and a region that is predicted to avoid potential secondary conflicts. The predication of avoidance can be based on different criteria and based on the severity and scenario of the primary conflict. For example, the clearance region may be defined by segments of a road along specific lane or lanes, defined by a range of trajectories calculated from vehicle dynamic models, among other approaches. Furthermore, the ego vehicle may vary the parameter according to a scenario and/or severity. For example, a more sever conflict would warrant a larger clearance region, whereas a less sever conflict may warrant a smaller clearance region. As another example, a scenario in which the primary conflict is on the side of a road may warrant a larger clearance region of a side in which other vehicles are traveling, whereas a side away from traffic may warrant a smaller clearance region. As another example, an ego vehicle that veers into oncoming traffic may warrant larger clearance region in view of severity and uncertainty as to where the ego vehicle will travel within the determined time period (T_{C}).

At operation 406 a post-conflict maneuver prediction is performed based on the post-conflict hazards check from operation 404. For example, operation 406 comprises predicting trajectories of nearby vehicles based for the determined time period (T_{C}) based on intrinsically and extrinsically obtained vehicle data, as described above in connection with FIG. 3. The predicted trajectories may be representative of post-conflict maneuvers for the time period time period (T_{C}). Operation 406 may be executed by a future motion simulation performed using vehicle dynamic models and vehicle data.

At operation 408, a determination is made on whether there are nearby vehicles, not involved in the primary conflict, that may be affected by a potential secondary conflict. For example, operation 402 determines whether any nearby vehicles are at risk of a secondary conflict based on the predicted post-conflict maneuvers from operation 406 and second geographic area from operation 404. For example, operation 408 may comprise identifying nearby vehicles corresponding to predicted trajectories that intersect with the second geographic area. The identified vehicles are considered at risk of secondary conflict.

If the determination at operation 408 is not, process 400 proceeds to operation 410, where no post-conflict negotiation is needed and the process ends. Whereas, if the determination at operation 408 is affirmative, process 400 proceeds to operation 412.

In some examples, operations 404-408 can be performed by post-conflict hazard detection module 310 of FIG. 3. As such, additional details on these operations can be found above in connection with FIG. 3.

At operation 412, emergency post-conflict negotiations are initiated to reserve the second geographic area, predicted at operation 404, for the determined time period (T_{C}). For example, at operation 412, an ego vehicle (e.g., ego vehicle 302 of FIG. 3) may establish a maneuver message session with the nearby vehicles identified at operation 408 and compose maneuver messages for the identified vehicles. As described above, the maneuver messages can comprise the second geographic area, as well as other information that can be used for avoiding a secondary conflict. The maneuver messages can be transmitted, either through a targeted transmission to specific vehicles or broadcasted to the nearby vehicles, as described above in connection with FIG. 3. In some examples, operation 412 may be executed by one or more of emergency negotiation initiation module 312 and maneuver message composition module 314, as described above in connection with FIG. 3.

At operation 414, nearby vehicles receive the maneuver message. Nearby vehicles may obtain the information contained in the maneuver message and execute systems (e.g., vehicle systems 258) to act on the information. For example, the receiving nearby vehicles may be operated so to avoid the second geographic area.

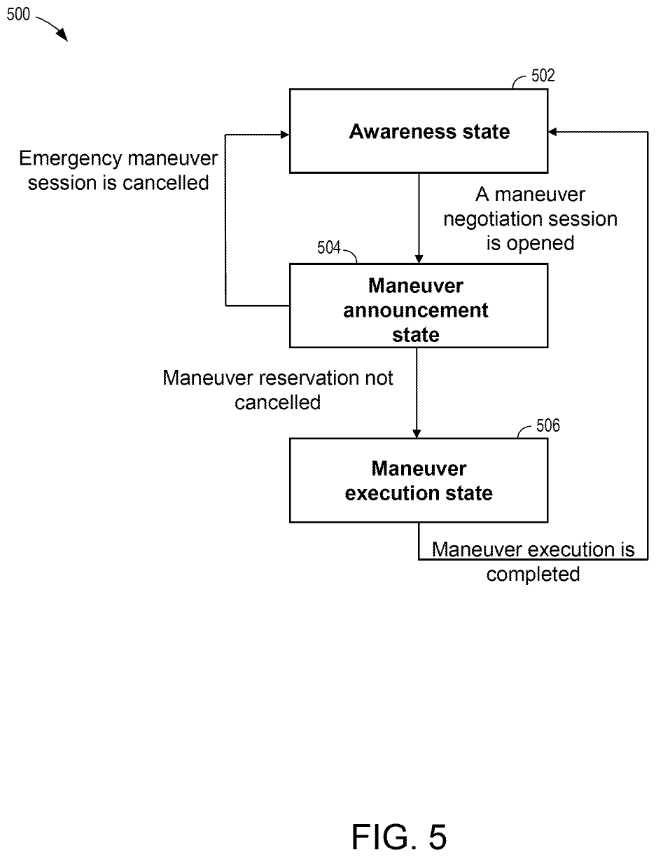

FIG. 5 is a flow chart illustrating example operations for emergency post-conflict negotiation initiation in accordance with various embodiments disclosed herein. FIG. 5 depicts process 500, which may executed as part of operation 412.

At operation 502, the ego vehicle enters an awareness state, during which the ego vehicle monitors current vehicle states based on intrinsic and extrinsic vehicle data. During operation 502, the ego vehicle, such as ego vehicle 302 of FIG. 3, may detect a primary conflict has occurred based on the vehicle states, predict trajectories for itself and (potentially) any other road agents involved in the primary conflict, and determine first and second geographic area based on the predicted trajectories. Operation 502 may also include identifying nearby vehicles that are at risk of a secondary conflict, as described above in connection with FIGS. 3 and 4. In some examples, operation 502 may include operations 402-408 of FIG. 4.

The ego vehicle can then open a maneuver negotiation session with the identified nearby vehicles and enter a maneuver announcement state at operation 504. During the maneuver announcement state, the ego vehicle may be configured to announce the detected primary collision and generate maneuver messages for coordinating maneuvers to minimize secondary conflicts.

For example, at operation 504, an ego vehicle may compose a first maneuver message (also referred to herein as a maneuver announcement message) configured to announce vehicle states of road agents involved in the primary conflict and coordinate maneuvers to minimize secondary conflicts. The maneuver announcement message may include information notifying the nearby vehicles that the ego vehicle has reserved the second geographic area for a determined period of time (T_{C}) and that the nearby vehicles should be operated to avoid the second geographic area for the determined period of time (T_{C}). In some examples, the maneuver announcement message may also comprise vehicle states, such as speed, position, and trajectory data of road agents involved in the conflict. In another example, the maneuver message may also comprise recommended trajectories for the nearby vehicle that define paths to avoid the second geographic area. In some embodiments, the maneuver announcement message may be an MM as described above, such as a MCM, MSCM, and the like.

In examples, the nearby vehicles that receive the maneuver announcement message may be configured to obtain the information contained in the message and configure in a manner to act on the information. For example, a nearby vehicle (e.g., vehicle 304 of FIG. 3) may receive a maneuver announcement message, decode the message to obtain the second geographic area and determined period of time (T_{C}), and then provide this information to its autonomous or semi-autonomous driving systems (e.g., autonomous or semi-autonomous driving systems 280). The autonomous or semi-autonomous driving systems may determine a trajectory for the nearby vehicle that avoids the second geographic area (e.g., does not intersect with the reserved second geographic area) for determined period of time (T_{C}).

In some cases, the emergency maneuver negotiation sessions may be cancelled. For example, in the case of a primary conflict detected as a potential collision, if the potential collision is avoided or does not occur, then the ego vehicle may send a second maneuver message cancelling the session (sometimes referred to herein as a maneuver cancellation message). In another example, the primary conflict may be completed prior to expiration of the determined period of time (T_{C}). In this case, the ego vehicle may issue a maneuver cancellation message. If the maneuver negotiation session is cancelled, process 500 returns to the operation 502 to monitor for another primary conflict.

If the maneuver message is not cancelled, the ego vehicle may enter a maneuver execution state 506, during which the ego vehicle transmits a maneuver execution message to the identified nearby vehicles. The maneuver execution message may instruct the identified nearby vehicles to operate the nearby vehicles according to the configurations determined above (e.g., based on receiving the maneuver announcement message). In this case, for example, a nearby vehicle may execute its autonomous or semi-autonomous driving systems to operate the vehicle to avoid the second geographic area. Once maneuver executions are completed by nearby vehicles and the determined period of time (T_{C}) has passed, depicts process 500 returns to operation 502.

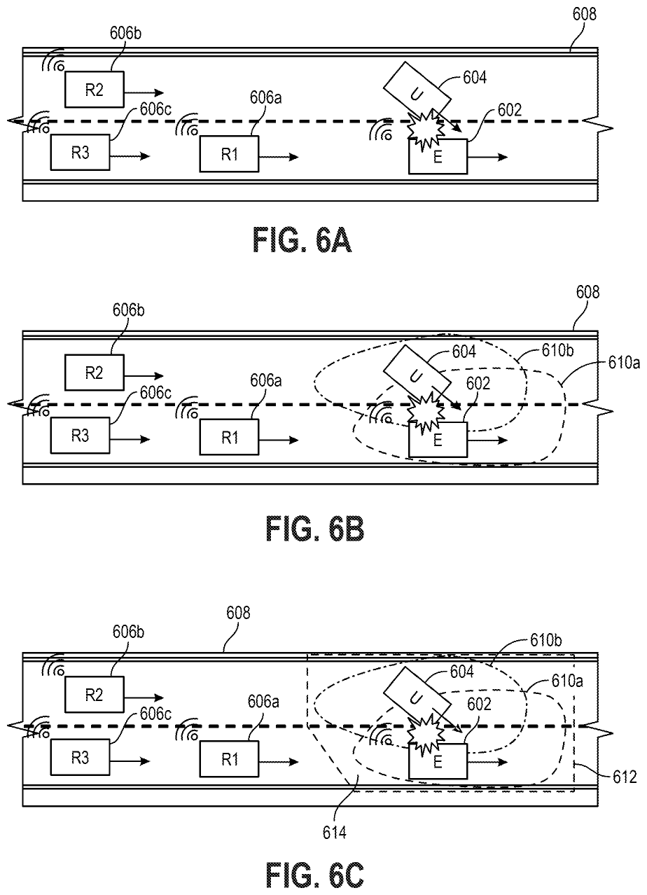

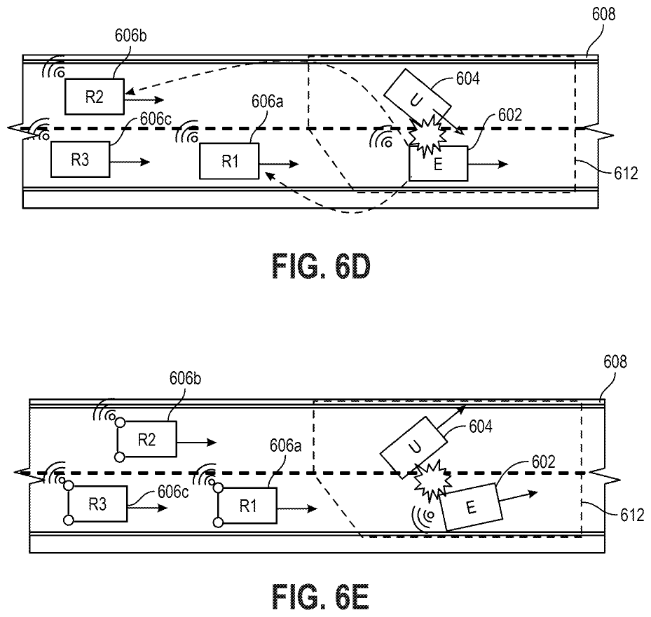

FIG. 6A-6E depict an example use case of post-collision negotiations in accordance with an embodiment. FIGS. 6A-6E depict a primary conflict between ego vehicle 602 and involved vehicle 604 in the form of a collision and remote vehicles 606a-606c in the vicinity of the collision. In this example, ego vehicle 602 may be implemented as ego vehicle 302 and remote vehicles 606a-606c may each be implemented as vehicle 304 of FIG. 3. As shown in FIGS. 6A-6E, in the vicinity may refer to remote vehicles 606a-606c traveling in a section of road 608 adjacent to (e.g., nearby) the conflict as identified based on a metric, as described above in connection with FIG. 3. In this example, involved vehicle 604 may have lost control and slid across the road 608, and eventually collides with the ego vehicle 602 (FIG. 6A).

Once collision happens, ego vehicle 602 evaluates the severity of the collision and determines the post-conflict hazards prediction horizon (e.g., determined time period T_{C}) is 10 seconds. Ego vehicle 602 then predicts its own trajectory, as well as the trajectory of involved vehicle 604, during the 10 seconds prediction horizon after the collision. As described above in connection with FIG. 3, the predictions may be done by using appropriate vehicle dynamics models, e.g., dynamic bicycle model with tire saturation. The results of prediction are the first sub-region 610a and second sub-region 610b that will be occupied by the ego vehicle 602 and involved vehicle 604, respectively, in the next 10 seconds, as shown in FIG. 6B. The size of the first and second sub-regions 610a and 610b can be determined to account for any uncertainty in the respective vehicles' future motion after collision. Collectively the first and second sub-regions 610a and 610b represent a first geographic area.

As shown in FIG. 6C, ego vehicle 602 can generate a larger combined geographic area, denoted as second geographic area 612, the comprises the predicted future trajectories of ego vehicle 602 and involved vehicle 604 (e.g., the first and second sub-regions 610a and 610b). In this case, clearance region 614 is added around first and second sub-regions 610a and 610b. This is where any other surrounding vehicles, if existing, should avoid in order to minimize secondary collisions.

After the post-conflict hazards evaluation described above, the ego vehicle 602 detects other nearby vehicles to determine whether negotiation is needed to ensure safety. This may include predicting trajectories of nearby vehicles and identifying those that may intersect with the second geographic areas 612. Distance and/or time metrics may be used to identify those vehicles that can be considered as in the vicinity of the collision and would be exposed to a post-conflict hazard, as described above in connection with FIG. 3. In this example, the metrics may be based on a time to a predicted collision or a time to conflict of each remote vehicle 606a-606c. In this example, ego vehicle 602 detects remote vehicles 606a-606c, and decides to initiate an emergency post-conflict negotiation with the detected remote vehicles 606a-606c.

Responsive to the above determination, ego vehicle 602 starts emergency post-conflict negotiation to reserve the second geographic areas 612 (FIG. 6D). This reserved second geographic areas 612, together with a reason code indicating an accident ahead, is included in reservation maneuver messages sent to the surrounding remote vehicles 606a-606c. The reservation maneuver message may be an example of a maneuver announcement message as described above.

Upon receiving the reservation maneuver message, the remote vehicles 606a-606c become aware of a conflict happening in front, together with a second geographic areas 612 they should avoid. Based on this information, in one example, 606a-606c slow down to stay outside the second geographic areas 612 for the next 10 seconds. This way, secondary conflicts can be avoided while the primary conflict proceeds to completion (FIG. 6E).

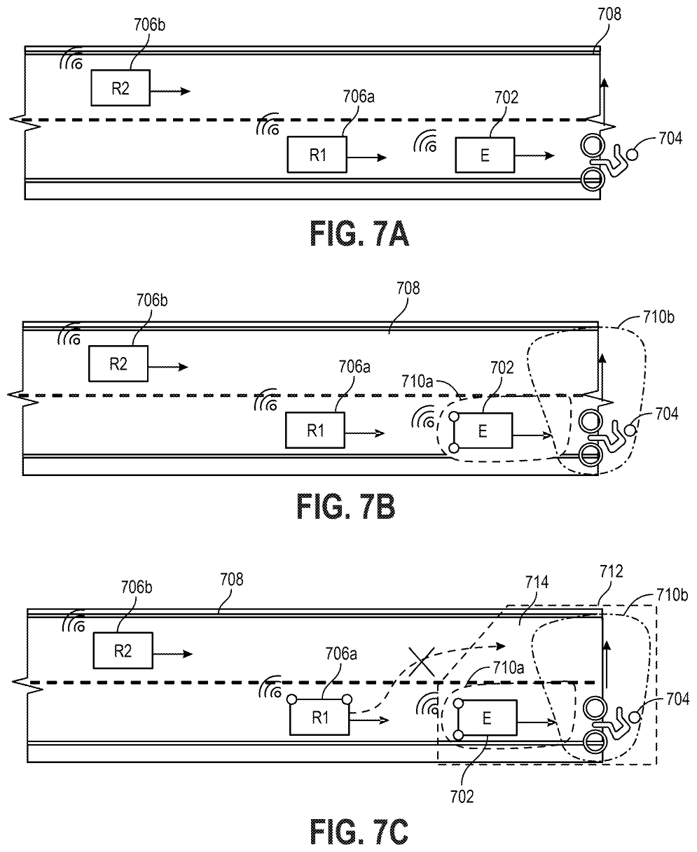

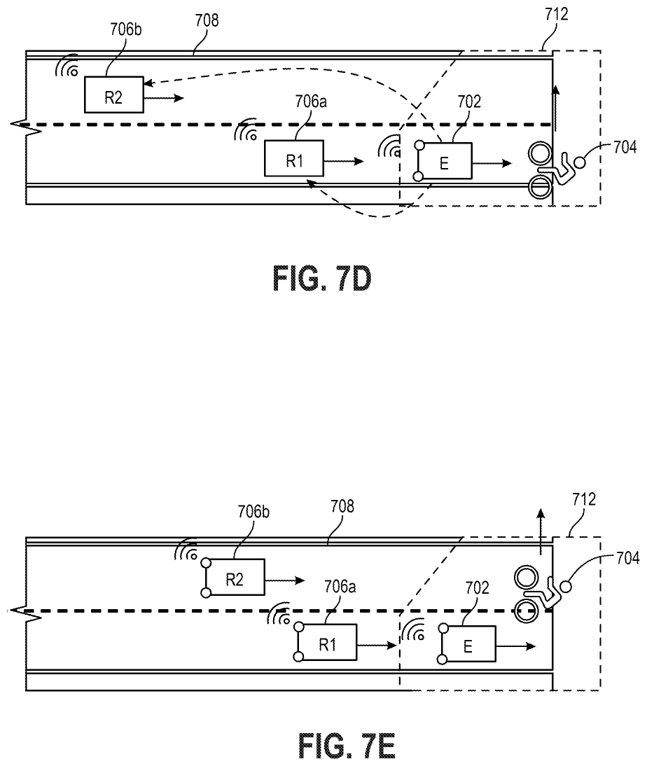

FIG. 7A-7E depict another example use case of post-collision negotiations in accordance with an embodiment. FIGS. 7A-7E depict a primary conflict between ego vehicle 702 and vulnerable road agent 704 in the form of a potential collision and remote vehicles 706a and 706b in the vicinity of the conflict. In this example, ego vehicle 702 may be implemented as ego vehicle 302 and remote vehicles 706a and 706b may each be implemented as vehicle 304 of FIG. 3. As shown in FIGS. 7A-7E, in the vicinity may refer to remote vehicles 706a and 706b traveling in a section of road 708 adjacent to (e.g., nearby) the conflict. In this example, ego vehicle 702 may be implemented as ego vehicle 302 and vulnerable road agent 704 may be a careless cyclist who unexpectedly crossed the road 708 causing a primary conflict, as shown in FIG. 7A. While a cyclist is depicted in FIGS. 7A-7E, any vulnerable road agent 704 may be any road agent, such as a pedestrian, animal, another vehicle, etc.

Once conflict happens, ego vehicle 702 evaluates the severity of conflict and determines the post-conflict hazard prediction horizon (e.g., determined time period T_{C}) is 12 seconds. Ego vehicle 702 then predicts its own trajectory (e.g., braking to avoid colliding with the vulnerable road agent 704), as well as the vulnerable road agent's trajectory (e.g., going across the rest of the road 708), during the next 12-second window. As described above in connection with FIG. 3, the predictions may be done by using appropriate vehicle dynamics models, e.g., dynamic bicycle model with tire saturation, or other dynamics models for involved road agents. Such prediction results in a first sub-region 710a and a second sub-region 710b that will be occupied by ego vehicle 702 and the vulnerable road agent 704, as shown in FIG. 6B. The size of the first and second sub-regions 710a and 710b can be determined to account for any uncertainty in the future motion of ego vehicle 702 and/or vulnerable road agent 704 during the conflict. Collectively the first and second sub-regions 710a and 710b represent a first geographic area.

As shown in FIG. 7C, ego vehicle 702 can generate a larger combined geographic area, denoted as second geographic area 712, the comprises the predicted future trajectories of ego vehicle 702 and vulnerable road agent 704 (e.g., the first and second sub-regions 710a and 710b). In this case, clearance region 714 is added around first and second sub-regions 710a and 710b. This is where other surrounding vehicles, if existing, should avoid in order to minimize secondary collisions. As an example, this second geographic area 712 indicates that, the remote vehicles 706a and 706b shall not overtake the slowing down ego vehicle 702.

After post-conflict hazards evaluation described above, the ego vehicle 702 detects other nearby vehicles around it to determine whether negotiation is needed to ensure safety. This may include predicting trajectories of nearby vehicles and identifying those that may intersect with the second geographic areas 712. Distance and/or time metrics may be used to identify those vehicles that can be considered as in the vicinity of the collision and would be exposed to a post-conflict hazard, as described above in connection with FIG. 3. In this example, the metrics may be based on a time to a predicted collision or a time to conflict of each remote vehicle 706a and 706b. In this example, ego vehicle 702 detects connected remote vehicles 706a and 706b, and decides to initiate an emergency post-conflict negotiation with the detected remote vehicles 706a and 706b.

Responsive to the above determination, ego vehicle 702 starts emergency negotiation to reserve the second geographic area 712 (FIG. 7D). This reserved second geographic area 712, together with a reason code indicating a moving vulnerable road agent 704, is included in reservation maneuver messages sent to the surrounding remote vehicles 706a and 706b. The reservation maneuver message may be an example of a maneuver announcement message as described above.

Upon receiving the reservation maneuver messages from the ego vehicle 702, the remote vehicles 706a and 706b become aware of a conflict caused by a vulnerable road user, together with a second geographic areas 612 they should avoid. Based on this information, the remote vehicle 706a may not overtake the slowing down ego vehicle 702 but just slow down, and vehicle 706b may also slow down to stay outside the second geographic areas 612 for the next 12 seconds. This way, secondary conflicts can be avoided while the conflict proceeds to completion (FIG. 7E).

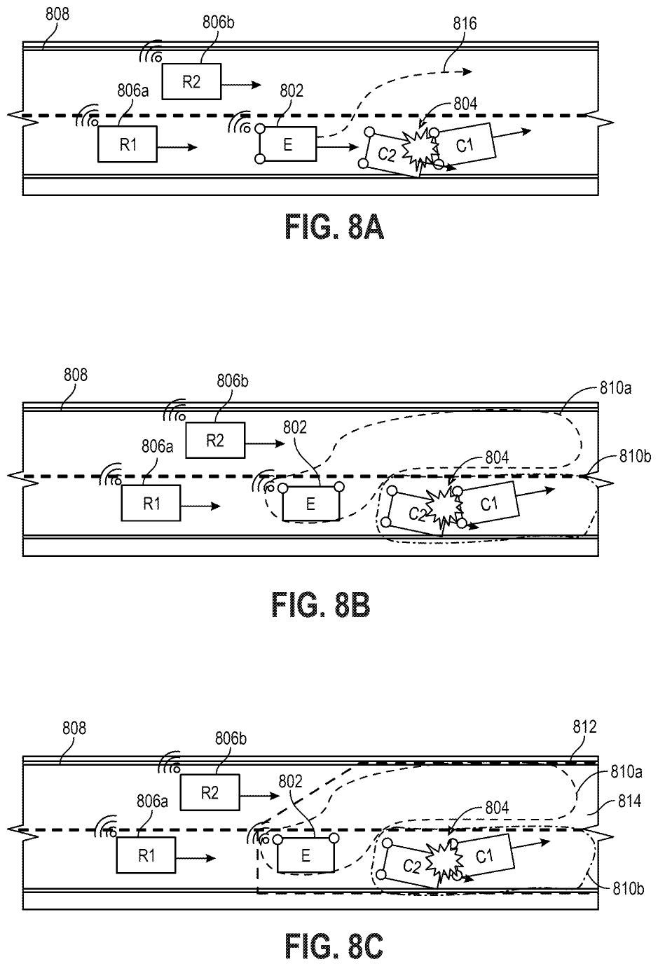

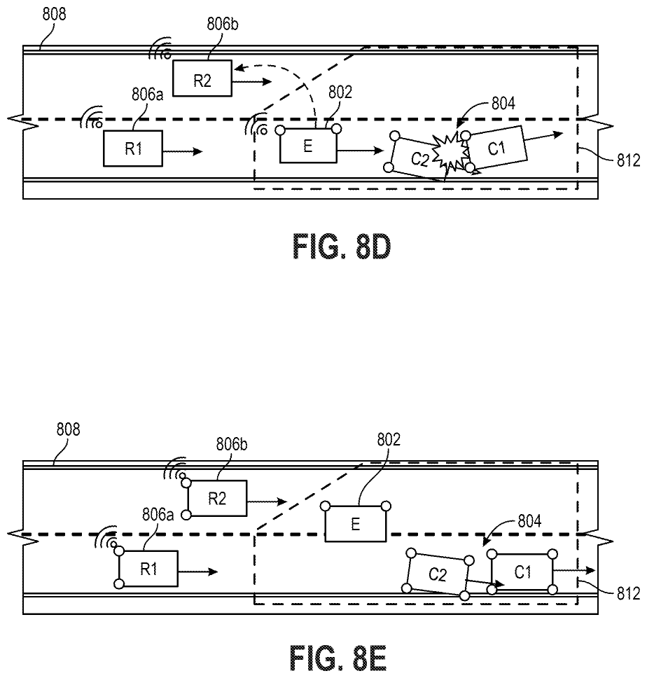

FIG. 8A-8E depict another example use case of post-collision negotiations in accordance with an embodiment. FIGS. 8A-8E depict a conflict between ego vehicle 802 and a collision 804 and nearby remote vehicles 806a and 806b in the vicinity of the conflict. In this example, ego vehicle 802 may be implemented as ego vehicle 302 and remote vehicles 806a and 806b may each be implemented as vehicle 304 of FIG. 3. As shown in FIGS. 8A-8E, in the vicinity may refer to vehicles 806a-806b traveling in a section of road 808 adjacent to (e.g., nearby) the conflict. In this example, ego vehicle 802 may be implemented as ego vehicle 302 and collision 804 may between two other road agents (e.g., vehicles in this example), as shown in FIG. 8A.

Since collision 804 happens in close vicinity of ego vehicle 802, ego vehicle 802 may find it impossible to come to a complete stop before hitting a road agent involved in the collision 804 while staying on the same lane. Thus, ego vehicle 802 may decide to perform minimum risk maneuver 816 by changing lanes, as shown in FIG. 8A. However, maneuver 816 may cause safety issue to other surrounding vehicles. The example shown in FIGS. 8A-8E shows an example how post-conflict negotiation can mitigate the negative safety impact of minimum risk maneuver on the traffic.

Once the collision 804 happens, ego vehicle 802 may evaluate the severity of conflict and determines the post-conflict hazard prediction horizon (e.g., determined time period T_{C}) is 8 seconds. For the next 8-second window, ego vehicle 802 predicts its own trajectory (e.g., changing lane to the left), as well as the trajectories of road agents involved in the collision 804. As described above in connection with FIG. 3, the predictions may be done by using appropriate vehicle dynamics models, e.g., dynamic bicycle model with tire saturation, or other dynamics models for involved road agents. Such prediction results in first sub-region 810a and second sub-region 810b that will be occupied by vehicle 802 and the road agents involved in collision 804, respectively, as shown in FIG. 8B. The size of the first and second sub-region 810a and 810b is determined to account for any uncertainty in the future motion of ego vehicle 802 and/or vulnerable road agents of collision 804. Collectively the first and second sub-regions 810a and 810b represent a first geographic area.

As shown in FIG. 8C, ego vehicle 802 can generate a combined geographic area, denoted as second geographic area 812, the comprises the predicted future trajectories of ego vehicle 802 and road agents involved collision 804 (e.g., the first and second sub-region 810a and 810b). In this case, clearance region 814 is added around first and second sub-region 810a and 810b. This is where other surrounding vehicles, if existing, should avoid in order to minimize secondary collisions. This second geographic area 812 indicates that, the remote vehicle 806b shall be prepared for a lane change performed by ego vehicle 802.

After post-conflict hazards evaluation described above, the ego vehicle 802 detects other vehicles around it to determine whether negotiation is needed to ensure safety. This may include predicting trajectories of nearby vehicles and identifying those that may intersect with the second geographic areas 812. Distance and/or time metrics may be used to identify those vehicles that can be considered as in the vicinity of the collision and would be exposed to a post-conflict hazard, as described above in connection with FIG. 3. In this example, the metrics may be based on a time to a predicted collision or a time to conflict of each remote vehicle 806a and 806b. In this case, ego vehicle 802 detects remote vehicles 806a and 806b, and decides to initiate an emergency negotiation with the detected remote vehicles 806a and 806b.

Responsive to the above determination, ego vehicle 802 starts emergency negotiation to reserve the second geographic area 812 (FIG. 8D). This reserved second geographic area 812, together with a reason code indicating the minimum risk maneuver 816, is included in reservation maneuver message sent to the surrounding remote vehicles 806a and 806b.

Upon receiving the reservation maneuver message from the ego vehicle 802, the remote vehicles 806a and 806b become aware of a minimum risk maneuver 816 that the ego vehicle 802 has to perform in order to avoid a secondary conflict caused by a collision 804. This abrupt minimum risk maneuver 816 is relayed to remote vehicles 806a and 80b by reserving the minimum risk maneuver 816 that other remote vehicles should avoid. Based on this information, the remote vehicles 806a and 806b slow down to stay outside the second geographic area 812, which allows the ego vehicle 802 to perform the emergency lane change for the next 8 seconds, as shown in FIG. 8E. This avoids a further secondary conflicts between remote vehicles 806a and/or 806b and the ego vehicle 802.

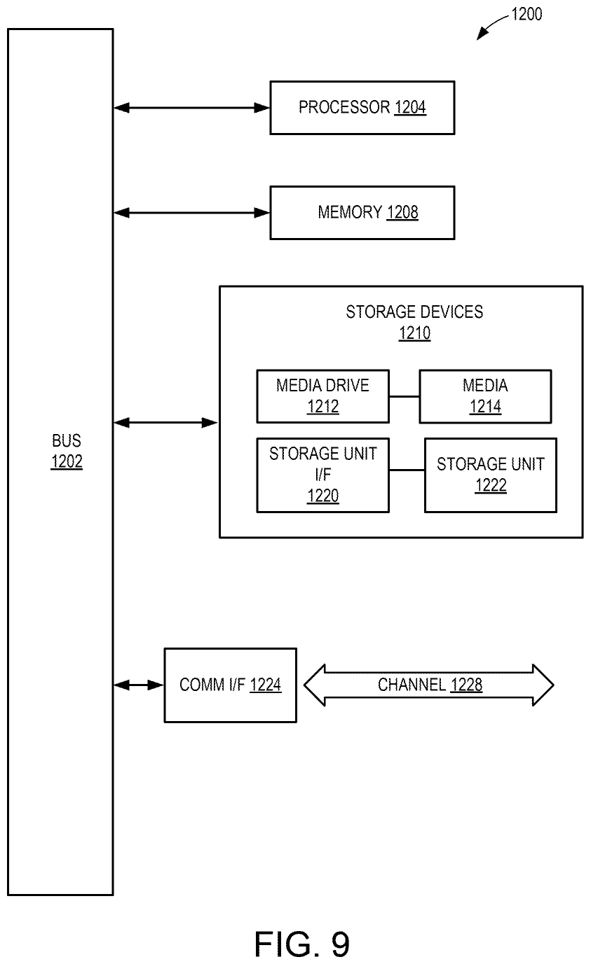

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components making up emergency conflict negotiation system 200 of FIG. 2 (e.g., post-conflict negotiation circuit 210). Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Memory storing instructions re any flowcharts. Main memory 908 might also be used for storing temporary variables or other intermediate information during execution of instructions to be executed by processor 904. For example, main memory 908 may store instructions for performing one or more operations of process 400 of FIG. 4 and/or process 500 of FIG. 5. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and an interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 922, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
detecting a conflict involving an ego vehicle;
determining a trajectory of the ego vehicle for a time period after detecting the conflict;
predicting a geographic area occupied by the trajectory of the ego vehicle for the time period;
identifying one or more remote vehicles adjacent to the geographic area; and
initiating negotiations with the identified one or more remote vehicles that reserves the geographic area for the detected conflict and the determined trajectory.

2. The method of claim 1, further comprising:
determining a trajectory of an object involved in the conflict for the time period;
wherein the geographic area is further predicted based on the determined trajectory of the object.

3. The method of claim 2, wherein predicting the geographic area comprises:
predicting a first sub-region based on the trajectory of the ego vehicle;
predicting a second sub-region based on the trajectory of the object; and
predicting the geographic area based on combining the first and second sub-regions.

4. The method of claim 3, wherein the predicted geographic area defines an area that encompasses the combined first and second sub-regions plus a clearance region.

5. The method of claim 1, wherein the trajectory of the ego vehicle is determined based on intrinsic vehicle data obtained from sensors installed on the ego vehicle.

6. The method of claim 1, wherein the trajectory of the ego vehicle is determined based on extrinsic vehicle data obtained by the ego vehicle from another vehicle.

7. The method of claim 1, further comprising:
determining that the identified one or more remote vehicles are at risk of a secondary conflict based on the geographic area,
wherein initiating the negotiations is responsive to the determination that the one or more remote vehicles are at risk of a secondary conflict.

8. The method of claim 7, wherein determining that the identified one or more remote vehicles are at risk of a secondary conflict further comprises:
predicting trajectories of the identified one or more remote vehicles for the time period; and
determining that one or more trajectories corresponding to the identified one or more vehicles intersects with the geographic area.

9. The method of claim 8, further comprising:
receiving, by the ego vehicle from the plurality of remote vehicles, at least one of: Basic Safety Messages, Maneuver Messages, and Sensor Data Messages,
wherein at least one of the detecting of the plurality of remote vehicles and the predicting of trajectories of the plurality of remote vehicles is based on the at least one of: Basic Safety Messages, Maneuver Messages, and Sensor Data Messages.

10. The method of claim 1, further comprising:
transmitting, by the ego vehicle to the identified one or more remote vehicles, one or more maneuver messages that comprise information indicating that the ego vehicle reserved the geographic area for the time period.

11. The method of claim 10, wherein the one or more maneuver messages comprises one or more recommended trajectories for the identified one or more remote vehicles to avoid the geographic area.

12. The method of claim 10, wherein the one or more maneuver messages are one of: Maneuver Coordination Messages and Maneuver Sharing Coordination Messages.

13. A vehicle, comprising:
a memory storing instructions; and
one or more processors communicably coupled to the memory and configured to execute the instructions to:
detect a conflict involving the vehicle;
determine a first trajectory of the vehicle for a time period after detecting the conflict;
predict a geographic area occupied by the first trajectory for the time period;
identify one or more remote vehicles adjacent to the geographic area; and
initiate negotiations with the identified one or more remote vehicles that reserves the geographic area for the detected conflict and the first trajectory.

14. The vehicle of claim 13, wherein the one or more processors are further configured to execute the instructions to:
determine a trajectory of an object involved in the conflict for the time period;
wherein the geographic area is further predicted based on the determined trajectory of the object.

15. The vehicle of claim 13, wherein the one or more processors are further configured to execute the instructions to:
predict a first sub-region based on the trajectory of the vehicle;
predict a second sub-region based on the trajectory of the object; and
predict the geographic area based on combining the first and second sub-regions.

16. The vehicle of claim 13, wherein the one or more processors are further configured to execute the instructions to:
determine that the identified one or more remote vehicles are at risk of a secondary conflict based on the geographic area,
wherein initiating the negotiations is responsive to the determination that the one or more remote vehicles are at risk of a secondary conflict.

17. The vehicle of claim 16, wherein the determination that the identified one or more remote vehicles are at risk of a secondary conflict further comprises:
predicting trajectories of the identified one or more remote vehicles for the time period; and
determining that one or more trajectories corresponding to the identified one or more vehicles intersects with the geographic area.

18. The vehicle of claim 13, wherein the one or more processors are further configured to execute the instructions to:
transmit, to the identified one or more remote vehicles, one or more maneuver messages that comprise information indicating that the vehicle reserved the geographic area for the time period.

19. A system, the system comprising:
a post-conflict negotiation circuit configured to execute instructions stored in a memory to:
detect a conflict including an ego vehicle; and
based on detecting the conflict, transmit one or more maneuver messages to one or more remote vehicles adjacent to the conflict, the one or more maneuver messages comprising information indicating a geographic area for the conflict and instructions for the one or more remote vehicles to avoid the geographic area.

20. The system of claim 19, wherein the post-conflict negotiation circuit is further configured to:
determine a trajectory of the ego vehicle for a time period after detecting the conflict;
predict a geographic area occupied by the trajectory of the ego vehicle for the time period; and
identify the one or more remote vehicles.
